(19) United States
(12) Patent Application Publication
(10) Pub. No.: US 2003/0069648 A1
(43) Pub. Date: Apr. 10, 2003

(54) System and method for monitoring and managing equipment

(76) Inventors: Barry Douglas, Doylestown, PA (US); Dan Pohly, Lake Worth, FL (US)

Correspondence Address: COLLIER, SHANNON, SCOTT, PLLC, 3050 K STREET, NW, SUITE 400, WASHINGTON, DC, 20007, US

(21) Appl. No.: 10/237,704

(22) Filed: Sep. 10, 2002

Related U.S. Application Data
(60) Provisional application No. 60/317,942, filed on Sep. 10, 2001.

(51) Int. Cl. G05B 19/18

(52) U.S. Cl. 700/2; 705/9; 340/568.1

(57) ABSTRACT

The present invention relates to a system and method for tracking, monitoring, and managing equipment. An embodiment of the system for monitoring and managing equipment comprises: one or more mobile pieces of equipment; one or more fixed pieces of equipment; a central processing system; and one or more means for communicating data between said equipment and said central processing system. The data may be location or status data, in particular real-time data about the equipment.

### CROSS-REFERENCE TO RELATED APPLICATIONS

The present invention relates to, and is entitled to the benefit of the earlier filing date and priority of, U.S. application Ser. No. 60/317,942, filed on Sep. 10, 2001, a copy of which is incorporated herein by reference.

### FIELD OF THE INVENTION

The present invention relates to a system and method for tracking, monitoring, and managing equipment. An embodiment of the present invention comprises a modular system of hardware and software components that acquires and collects data from equipment, machines, and/or systems and processes this information so that manual or automated decision making processes can be made to remotely and/or optimally monitor, control, dispatch, or maintain the equipment, machines, or systems. An embodiment of the present invention may be used to track and monitor support and gate equipment in an airport operation. The present invention may be adapted to a variety of other applications, such as, but not limited to: shipping ports; manufacturing facilities; warehousing; distribution; trucking; agriculture; hospitals; general industry; and a wide variety of other applications in which the benefits of the system and/or method of the present invention may improve efficiency, reliability, or other desired aspects of the operation.

### BACKGROUND OF THE INVENTION

Many operations in our society require the integration and coordination of multiple assets (machines, equipment, systems, personnel, etc.) into complex systems and/or methods of operation. Appropriate control and use of these assets is often the key to effectiveness and/or profitability of the businesses in which they are used. Accurate and reliable information about these assets is essential to optimize their use. Typically, however, this information is not readily available. In many businesses, it is at best available periodically and even when it is available, it is typically incomplete and/or inaccurate. In many situations the cost of acquiring this information is prohibitive.

For example, and without limiting the present invention to any particular application or embodiment, a large industrial operation, such as an airport, has hundreds or thousands of assets to manage. These assets may include, but are not limited to: push-back tractors; fuel trucks; catering trucks; loaders; plows; fire and other emergency equipment; tow bars; passenger boarding bridges; and a myriad of other equipment. Each piece of equipment may be essential to some aspect of the safe and effective functioning of the airport facility. Nonetheless, particularly in large operations, it is prohibitive to devote the resources that would be necessary to track and monitor each piece of equipment.

As a result, many operations purchase more equipment than would be needed were the assets scheduled so as to optimize the use of each asset. Assets may be moved, mislocated, damaged, or lost, without explanation. Frequently, equipment is under-utilized and poorly maintained.

Prior to the present invention, personnel faced with the task of using and controlling assets have had few useful tools to help them manage these assets. The result is: excess capital expenditure; poor utilization of assets; poor capacity utilization of existing equipment; improper or poor maintenance. Often, the life of the equipment is shortened and the return on investment in the equipment is a fraction of what it could were it optimally used. This situation is common in many industries, and offers a tremendous opportunity for savings. In many instances, the bigger the operation, the greater the opportunity for process improvement and savings.

Attempts have been made to address some or all of these problems. For example, automated data acquisition and monitoring systems are well known prior to the present invention, in a wide variety of applications. Some of these systems have been employed in factories, airports, and in general industry to monitor fixed equipment or mobile equipment. Yet, prior known systems typically do not combine the functions of monitoring both fixed and mobile equipment. The present inventors are not aware of prior known systems that combine in a single system monitoring of both fixed and mobile equipment. Further, prior known systems do not combine in a single system acquisition of status telemetry with real time locating technology to enable monitoring any combination of fixed equipment, powered mobile equipment, and non-powered mobile equipment.

Real-time location systems known prior to the present invention utilize various technologies to locate mobile machinery and equipment. The most common method is the use of Global Positioning System (GPS) technology in conjunction with a cellular phone network to locate the equipment as well as communicate this information to a centrally located computer. An advantage of such a system is that it uses the preexisting GPS satellite infrastructure and can be designed to provide good location accuracy (+/−25′). Coverage is available virtually anywhere in the world. A disadvantage of this approach is that GPS does not work indoors and is unreliable when a full view of the sky is not available. In addition, GPS units are expensive and not practical for locating non-powered equipment. The recurring cost of transmitting information over a cellular phone network is also an issue.

Another technology that is known is long-range proximity tracking. This requires the use of a radio network to locate equipment. A radio frequency (RF) network of antennas is installed to listen for a transmitter mounted on the equipment to be located. Depending on the radio frequency used, this technology may compete with other local applications for air space. The approximate position of the equipment can be determined by simply evaluating the antenna in the radio network that has the strongest reception of the radio signal. The practical accuracy of such a system is significantly less than either GPS or the present invention (+/−300 ft). The equipment to be located must be within range of any listening antenna in the RF network (300′-500′).

Short-range proximity tracking is another alternative. A high-powered RF antenna is used to excite a passive RF identification (RFID) tag which is mounted on the equipment to be located. Once excited, the passive tag responds with a short RF burst that indicates it is within range of the high-powered RF antenna. Although the cost of the RFID tag is the lowest of any of the prior known alternatives, a major drawback of this technology is that the RFID tag must be within a few feet of the high-powered antenna to be detected.

An alternative approach involves installing an RF network of antennas that periodically requests status from RF devices mounted on the equipment. The equipment-mounted devices respond to the RF network. The system determines the time it takes between sending the request and receiving a response and triangulates the position of the equipment. The equipment must be within range of the antenna network (200′-300′) and the accuracy of the location information is good (+/−25′). A disadvantage of this approach is that the system generates a substantial amount of RF noise, as all pieces of the system are actively transmitting at high RF power levels. On non-powered equipment, battery powered devices will last only a few days due to the heavy power demands of the technology.

The locate capability of embodiments of the present invention provides significant advantages over prior known approaches. The low cost of the per unit equipment-mounted device makes it practical to install on both powered and non-powered equipment. Recurring costs are low because it uses its own RF network. The only cost is the initial installation of the infrastructure. This technology can work outdoors, indoors, and in close proximity to large structures. The locate accuracy is substantially better than other approaches (+/−10′). In addition, the low power RF output of each device does not interfere with existing RF systems and does not require special approval or licensing.

Data acquisition and monitoring systems have also been used in conjunction with computerized maintenance management systems (CMMS) prior to the present invention. For example, a system was installed at Denver International Airport to monitor a portion of the baggage handling system. This system passed real-time information about equipment defaults from the monitoring system to the maintenance system. The Denver CMMS automatically opens a work order for a fault and pages a maintenance technician. Upon completion of the task, the technician closes the work order using keyboard input at a computer terminal. The technician enters task information and time and materials consumed. The CMMS assigns costs to the work order and closes it. The system also generates hardcopy management reports. This system can also use barcode scanning technology to assign materials to work orders and manage spare parts inventory. The system, however, was plagued by defects initially and, as eventually deployed, performs only a portion of the work initially intended. See Wyatt Gibbs, “Software's Chronic Crisis,” SCIENTIFIC AMERICAN, 86-95 (September 1994), which is incorporated herein by reference in its entirety.

Computer-based financial management systems are well known prior to the present invention and are available from many sources. Similarly, CMMS are well known. Both are available in a variety of configurations and capabilities, from a variety of sources. The characteristics and capabilities of these systems are well known to persons of ordinary skill in the art. The maintenance system of embodiments of the present invention offers many of the same capabilities that other packages provide. Embodiments of the present invention, however, offer additional unique advantages and functions not found in prior known products and applications. These may include a web-based architecture for the software, which allows a user to access the system through the Internet with standard browser software. In addition, embodiments of the present invention may include skilled trade manpower tracking, including individual technical certifications, and a random audit check function that requires a worker to occasionally obtain a supervisor's signature to verify that work has been performed. Further, a customer may track multiple locations where work is performed within the same system.

Graphical user interfaces are well known and have been used in a wide variety of applications, not only in connection with tracking, monitoring, and control applications, but also with a wide variety of other software applications. Persons of ordinary skill in the art are readily familiar with their characteristics and use. In particular, graphical user interfaces have been used to monitor and track equipment. These user interfaces typically contain schematic representations of equipment being monitored, together with real-time data about equipment operating parameters. For example, systems that have been used in the trucking industry combine real-time location data with status telemetry in the user interface. Nonetheless, the present inventors believe that a single user interface designed to integrate data obtained from both fixed and mobile equipment and, additionally, display the location and detailed status of the equipment is not known prior to the present invention.

Control systems that utilize card readers to enable vehicles and equipment only for authorized operators are known in the art prior to the present invention. These systems typically access a single database to determine an operator's authorization to operate a given piece of equipment. The database may either be centrally located on a computer or copied in its entirety to the memory of devices onboard each piece of equipment. Embodiments of the present invention, in contrast, do not require access to any database to determine operator authorizations for specific pieces of equipment. Instead, each operator may be issued a card that contains the code for the equipment they are authorized to use along with a unique personal identification number (PIN). An advantage of this system is that if access is not possible to the central control computer, then the equipment can still be operated safely. This feature is also believed to be novel.

Remote modification of set points and other control parameters in machinery has become common in the building automation and management industry. Remote uploading of control software has been done in this industry as well.

With respect to airports, in particular, aircraft boarding bridges have historically been operated from a control cab at the end of the boarding bridge. Prior known control systems did not offer the capability to remotely control multiple aircraft passenger boarding bridges by a single centralized, or multiple remote, operator. Although automated docking of passenger boarding bridges, using a link to a visual docking guidance system for positioning information, has been tested in Copenhagen, Denmark and Newcastle, England, systems including the advanced features of the present invention were not known in the art. In addition, a system to weigh aircraft and provide feedback to operator loading and balancing the aircraft for optimal flight is not known.

Therefore, although a number of specific systems are known that may be used to provide certain types of data, or to track, monitor, or control limited pieces of equipment or features of certain types of equipment, there remains a substantial need for methods and systems to track, monitor, and/or control equipment, particularly in complex operational settings. That substantial and long felt need has not been met by prior known solutions.

Although certain tracking systems have been effective at limited applications, such as the systems used by Federal Express to track shipments within their system, the problems that have been experienced with more complex tracking and handling systems have been so pervasive that it has led some designers and managers away from further efforts, teaching away from the present invention. There remains therefore, a substantial, long felt need for effective solutions for tracking, monitoring, and controlling equipment in complex systems.

Specifically, numerous specific needs have not been met by prior known approaches. Although various data acquisition and monitoring systems are known, none have combined the tracking and/or monitoring of both fixed and mobile equipment in a single system. Similarly, prior known systems have not combined status information with real time locating technologies to track and monitor any combination of fixed, powered mobile, and non-powered mobile equipment.

Consequently, prior known graphical user interface systems have not integrated data obtained from both fixed and mobile equipment, nor have they displayed the locations of the equipment. Prior known authorization systems have also been limited by requiring access to a database to determine operator access to equipment. Nor have prior known systems offered the ability remotely to control multiple boarding bridges, either from a single or multiple, remote locations. Prior known systems similarly have failed to monitor aircraft and other equipment conditions during loading, such as but not limited to weight, and provide feedback to the operator.

Embodiments of the present invention address many of the shortcomings of prior known systems, methods, and apparatus for the tracking, monitoring, and control of equipment. For example, an embodiment of a process of the present invention provides equipment maintenance while eliminating paperwork. Other embodiments of the present invention combine location data with other status data about the equipment and/or its operating environment to produce operational information that is not otherwise available through prior known systems. Other embodiments allow load planners to analyze data about the loading of an aircraft to optimize aircraft balance without having to rely upon a combination of manual and automatic systems known prior to the present invention. Other embodiments of the present invention combine real-time monitoring of the status of equipment with location tracking. In other embodiments, these tools are available for a combination of fixed, powered mobile, and non-powered mobile equipment, in contrast to prior known systems which are capable of tracking only one of the three types of equipment. Additional embodiments of the present invention may employ real-time tracking of equipment to improve business processes and performance in the applications in which the equipment is used. In other embodiments, the present invention may control operator access to equipment, permitting only trained personnel to operate equipment.

The foregoing examples are illustrative and exemplary only and serve to illustrate some of the advantages of certain of the embodiments of the present invention. They are not intended to limit the scope of the present invention as claimed in the appended claims and their equivalents.

It is therefore an advantage of some, but not necessarily all, embodiments of the present invention to provide a system to optimize the use of assets.

It is another advantage of some, but not necessarily all, embodiments of the present invention to provide a method for improving the tracking and management of assets.

Another advantage of some, but not necessarily all, embodiments of the present invention is to provide a means for increasing the output of an operation by improving the utilization of assets used in the operation.

Yet another advantage of some, but not necessarily all, embodiments of the present invention is to extend the life of equipment used in an operation by extending the useful life of equipment used in the operation.

It is another advantage of some, but not necessarily all, embodiments of the present invention to provide increased savings to an operation by improving the utilization of equipment used in the operation.

It is another advantage of some, but not necessarily all, embodiments of the present invention to provide real-time data on the status of assets.

Another advantage of some, but not necessarily all, embodiments of the present invention is to pass pertinent information to systems that are adapted to store and display the information.

It is another advantage of some, but not necessarily all, embodiments of the present invention to centralize the flow of information about assets to optimize the dispatch, control, and/or allocation of assets.

Yet another advantage of some, but not necessarily all, embodiments of the present invention is to provide a logistics process that automates the use of equipment, systems, and machinery used in an operation.

Another advantage of some, but not necessarily all, embodiments of the preset invention is to enhance safety of operations by limiting access to equipment to only authorized personnel.

A further advantage of some, but not necessarily all, embodiments of the present invention is to enhance safety by providing means to detect when equipment is located in areas where it should not be, such as in the pushback zone of an aircraft, when an aircraft is pushing off of the gate.

Yet another advantage of some, but not necessarily all, embodiments of the present invention is to enhance safety by providing a means to warn operators of potential collision hazards.

Additional advantages of various embodiment of the invention are set forth, in part, in the description that follows and, in part, will be apparent to one of ordinary skill in the art from the description and/or from the practice of the invention.

### SUMMARY OF THE INVENTION

Responsive to the foregoing challenges, Applicant has developed an innovative method and system for aggregating information about the status of assets in a centralized system. This centralized system is adapted to dispatch, control, and/or allocate assets, including equipment, systems, and machines. In an embodiment of the present invention, the system may be adapted to cooperate with other operational systems and logistical decision processes to automate the use of equipment, systems, and machinery.

According to an embodiment of the present invention, the system for monitoring and managing equipment comprises: one or more mobile pieces of equipment; one or more fixed pieces of equipment; a central processing system; and one or more means for communicating data between the equipment and the central processing system.

The mobile equipment may further comprise powered mobile equipment and non-powered mobile equipment. The communicating means may comprise a radio frequency network. The radio frequency network may further comprise at least one equipment mounted device communicating via low-power radio frequency with at least two antennae. Alternatively, the communicating means may comprise a cellular network.

The data may comprise data about a location of the equipment. The data may also comprise data about an operational status of the equipment.

The system may further comprise a graphical user interface enabling a user to interact with the central processing system. The system may further comprise means for remote operation of the equipment based upon the data communicated to the central processing system. The means for remote operation may be fully automated. The system may also further comprise means for controlling operator access to the equipment. The means for controlling operator access may further comprise: an onboard device mounted on the equipment that enables or disables the equipment; an identification card reader connected to the onboard device; one or more operator identification cards containing information about the operator, the identification cards being read by the identification card reader; and a database of operators, which communicates with the identification card reader.

In another embodiment of the present invention, the system for monitoring and managing equipment comprises: one or more mobile pieces of equipment; one or more fixed pieces of equipment; a plurality of distributed processing systems; one or more means for communicating data between the equipment and the processing systems; and means for remote operation of the equipment based on data communicated to the processing systems.

According the an embodiment of the present invention, the method for monitoring and managing equipment comprises the steps of: gathering data about one or more pieces of fixed equipment; gathering data about one or more pieces of mobile equipment; and communicating the data to a central processing system.

The step of gathering data about one or more pieces of mobile equipment may further comprise gathering data about the location of the equipment. The method may further comprise the step of processing the location data at the central processing system to determine the physical location of the mobile equipment. The step of processing the location data may further comprise the step of triangulating the physical location of the mobile equipment.

The step of gathering data about one or more pieces of equipment may further comprise the step of monitoring the operational status of the equipment. The step of monitoring the operational status may be selected from the group consisting of monitoring one or more of: equipment running status; faults and problems; hours of operation; fuel levels; fluid levels; cycles of operation; materials processed; items handled; tasks accomplished; and operator information.

The step of communicating the data may further comprise communicating via a radio frequency network. Alternatively, the step of communicating the data may further comprise communicating via combination of a radio frequency network and a global positioning system network. The step of communicating the data may also further comprise inputting data via a device selected from the group consisting of: keyboard entry; wireless handheld device; voice recognition; optical scanning; character recognition; and automatic data collection.

The method may further comprise the step of remotely operating the equipment based upon data communicated to the central processing system. The step of remotely operating the equipment may further comprise automatically dispatching the equipment.

The method may also further comprise the step of controlling operator access to the equipment. The step of controlling operator access may further comprise the steps of: identifying an operator of the equipment; determining authorization to operate the equipment based upon the operator identification; and enabling the equipment if authorization is allowed. The step of controlling operator access may further comprise the step of disabling the equipment after a configurable of time.

The method may further comprise the step of maintaining the equipment based on the data communicated to the central processing system. The method may also further comprise the step of managing the finances of a business based on the data communicated to the central processing system.

An embodiment of the present invention is also directed to a method for maintaining equipment, comprising the steps of: remotely sensing a need for maintenance; communicating the need to a central processing system; re-allocating the equipment's tasks; opening a work order for the maintenance task; assigning the task to the appropriate maintenance personnel; acknowledging receipt of the assignment; recording in a manner adapted to communicate with the central processing system events during task completion; recognizing the availability of the equipment; and notifying the central processing system that the equipment is available for use. The method may further comprise the steps of: assigning cost, productivity, and inventory information to the work order; accounting for the maintenance according to generally accepted accounting principles; and reporting parameters relating to the maintenance.

It is to be understood that both the foregoing general description and the following detailed description are exemplary and explanatory only, and are not restrictive of the invention as claimed. The accompanying drawings, which are incorporated herein by reference, and which constitute a part of this specification, illustrate certain embodiments of the invention, and together with the detailed description, serve to explain the principles of those embodiments of the present invention.

### BRIEF DESCRIPTION OF THE DRAWINGS

In order to assist the understanding of this invention, reference will now be made to the appended drawings, in which like reference characters refer to like elements. The drawings are exemplary only, and should not be construed as limiting the invention.

FIG. 1 is a block diagram representing an embodiment of the system for monitoring and managing equipment in accordance with an embodiment of the present invention.

FIG. 2 is a block diagram representing an embodiment of the central processing system of the system depicted in FIG. 1 in accordance with an embodiment of the present invention.

FIG. 3 is a block diagram depicting the interrelationship of various components of an embodiment of the present invention.

FIG. 4 is a screen print of an initial security log-on window in accordance with an embodiment of the present invention.

FIG. 5 is a screen print of a window that appears after successful login, depicting the layout of a facility and the location and status of equipment in accordance with an embodiment of the present invention.

FIG. 6 is a screen print of a window for configuring which equipment will be displayed in accordance with an embodiment of the present invention.

FIG. 7 is a screen print of a find window used to highlight a selected piece of equipment in accordance with an embodiment of the present invention.

FIG. 8 is a screen print of an equipment reports window in accordance with an embodiment of the present invention.

FIG. 9 is a screen print of an equipment reports window in accordance with an embodiment of the present invention.

FIG. 10 is a screen print of an equipment reports window in accordance with an embodiment of the present invention.

FIG. 11 is a screen print of an equipment reports window in accordance with an embodiment of the present invention.

FIG. 12 is a screen print of an initial configuration window in accordance with an embodiment of the present invention.

FIG. 13 is a screen print of an equipment window for selecting which equipment is currently available to the system in accordance with an embodiment of the present invention.

FIG. 14 is a screen print of an equipment window for defining equipment type in accordance with an embodiment of the present invention.

FIG. 15 is a screen print of an equipment window for defining instruments associated with equipment in accordance with an embodiment of the present invention.

FIG. 16 is a screen print of an equipment window for assigning equipment to a particular viewing group in accordance with an embodiment of the present invention.

FIG. 17a is a screen print of a new user registration window in accordance with an embodiment of the present invention.

FIG. 17b is a screen print of a user preferences window in accordance with an embodiment of the present invention.

FIG. 18 is a flowchart depicting the method for monitoring and managing equipment in accordance with an embodiment of the present invention.

### DETAILED DESCRIPTION OF EMBODIMENTS OF THE INVENTION

Reference will now be made in detail to an embodiment of the present invention, examples of which are illustrated in the accompanying drawings. As embodied herein, the present invention is a system and method for monitoring and managing equipment.

### System of the Present Invention

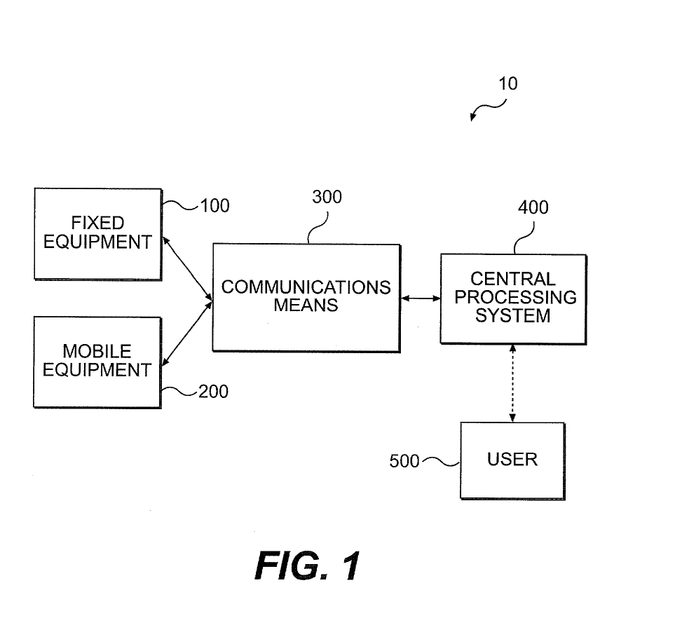

With reference to FIG. 1, the system for monitoring and managing equipment 10 may comprise: one or more mobile pieces of equipment 100; one or more fixed pieces of equipment 200; a central processing system 400; and one or more means for communicating data about the equipment to the central processing system 300. The mobile equipment may be powered mobile equipment and/or non-powered mobile equipment. The data about the equipment may comprise location and/or status data, particularly real-time data.

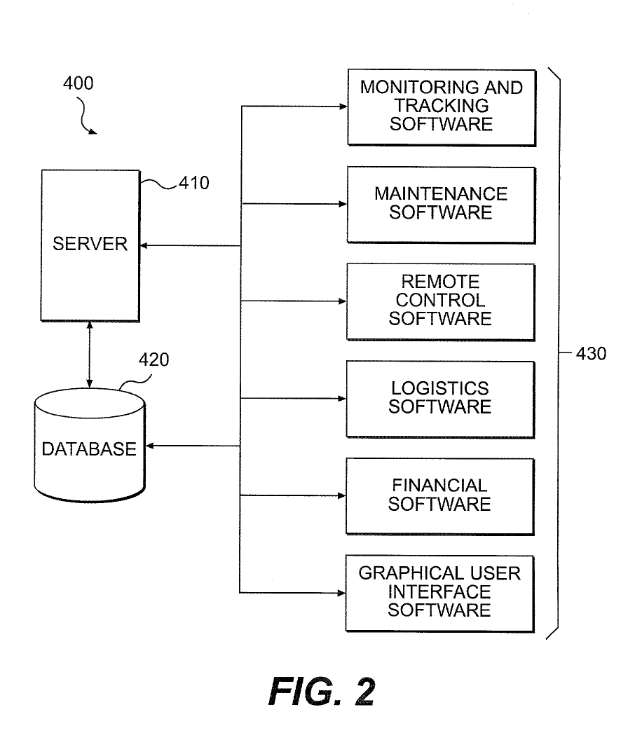

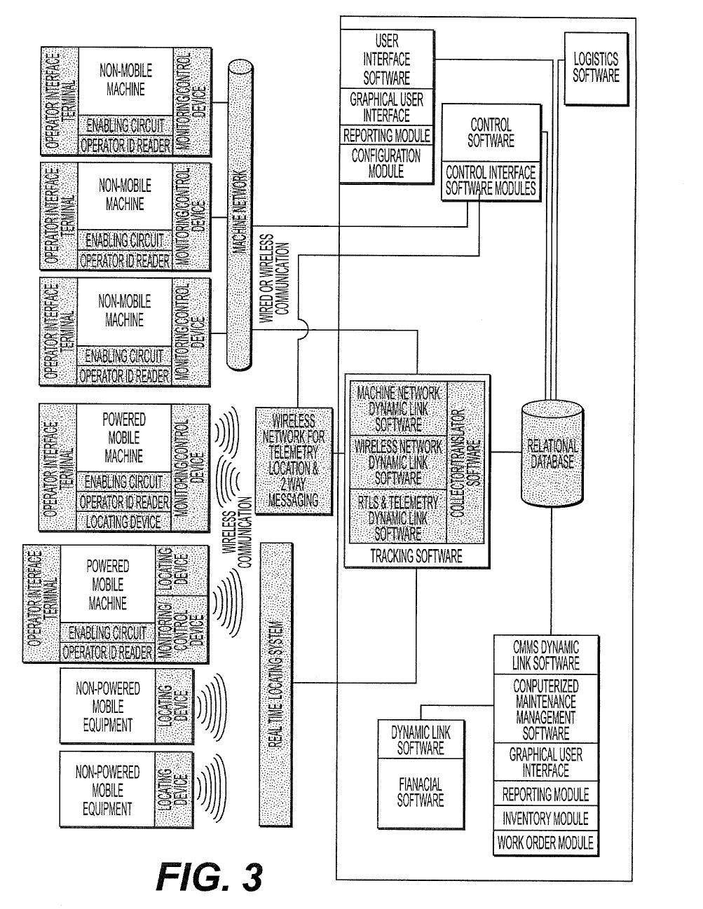

As depicted in FIG. 2, the central processing system 400 may comprise a single centralized server or multiple servers 410 and one or more database(s) 420 residing thereon. According to one embodiment, information may be controlled through a single server. In this manner, status information may be in one database and there is no chance of having two databases on two computers with conflicting information. The central processing system 400 may include software 430 containing program instructions for carrying out the functionalities of various embodiments of the present invention. It is also considered well within the scope of the present invention for multiple processing systems to be employed.

The means for communicating data to the central processing system 300 may be wireless or wired. Wireless communicating means may comprise a RF network, a cellular network and GPS, or any other suitable network for wireless communication between equipment 100/200 and the central processing system 400.

A wireless RF network may comprise equipment mounted devices, such as tags, and an antenna network. The equipment mounted devices may periodically send out a very low power locate signal. The antenna network, which may comprise two or more antennae, may passively listen for the signal to triangulate its location. The antenna network may communicate the collected location data to the central processing system 400 where physical location may be calculated by antenna proximity triangulation. Software 430 included in the central processing system 400 may be adapted to process this data and calculate the location. Software 430 may also be adapted to store this information on the database(s) 420. The low power RF design of such an embodiment allows devices to be mounted on non-powered equipment and still have a battery that will last for an extended period of time, about five to seven years. Other RF systems are known in the art and considered well within the scope of the present invention. Further, a RF network may work in combination with other means for communicating, such as GPS. A specific embodiment of the present invention may use locate technology provided by WhereNet.

The system 10 may further comprise user 500 for interacting with the central processing system 400. User 500 may be a graphical user interface or any other suitable system enabling interaction with the central processing system 400.

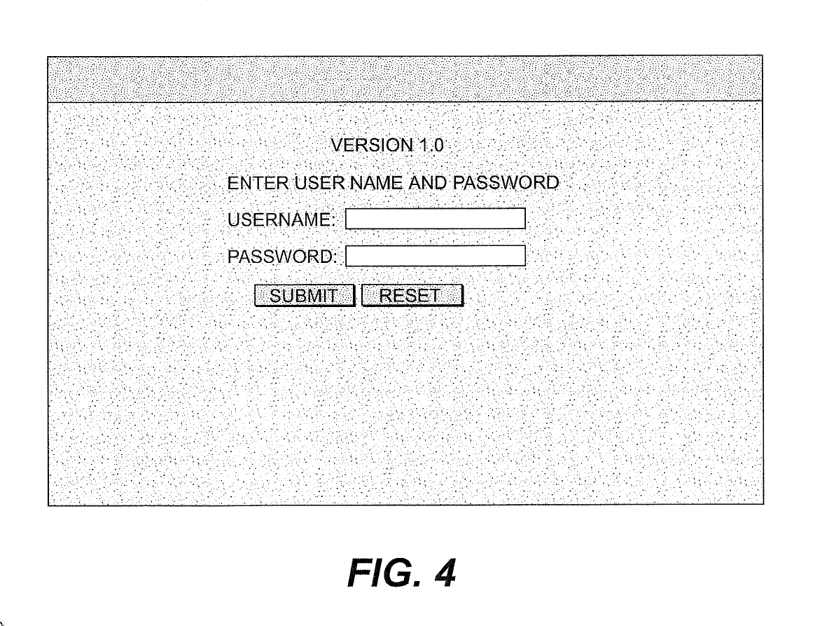

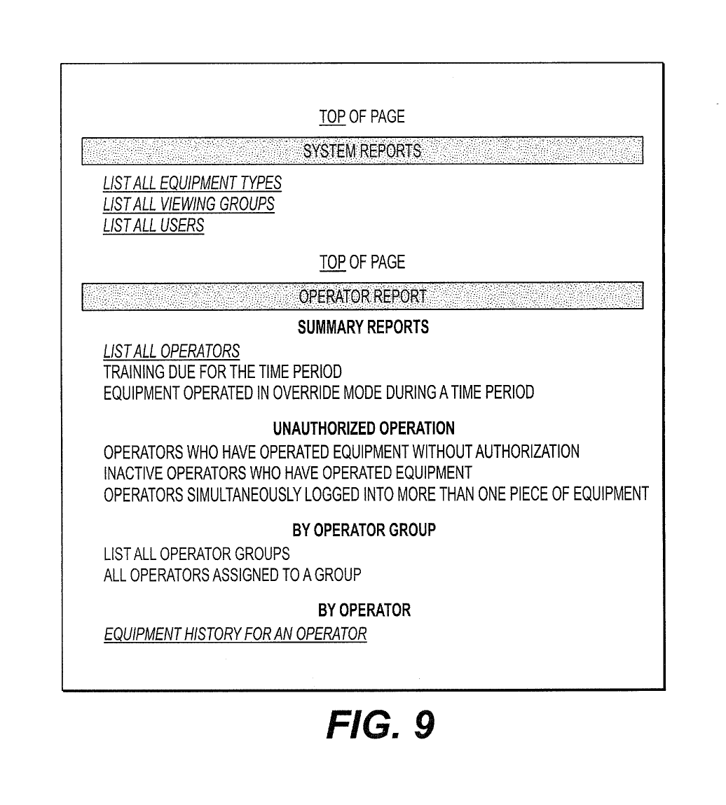

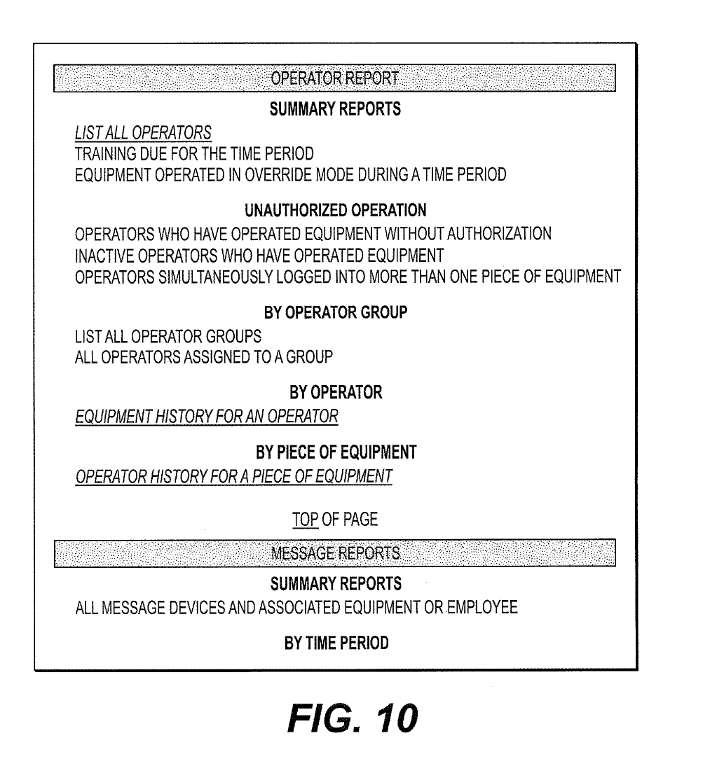

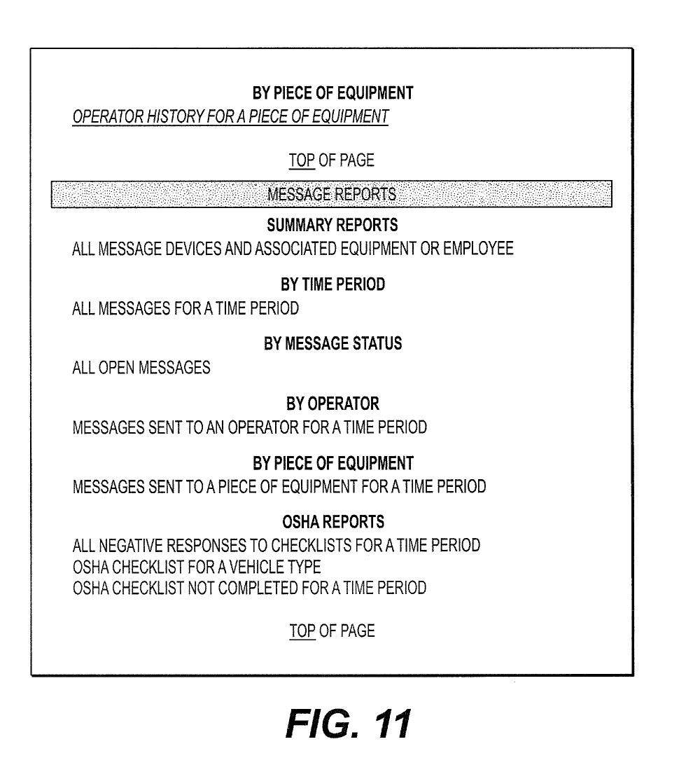

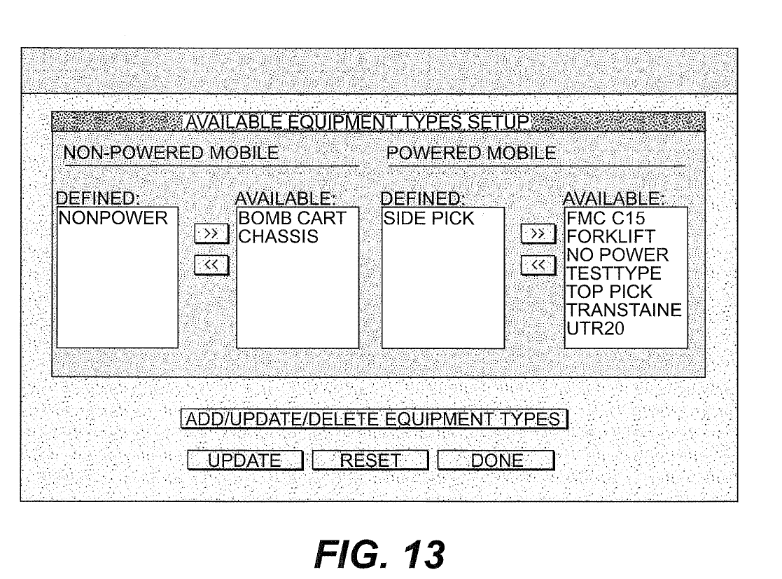

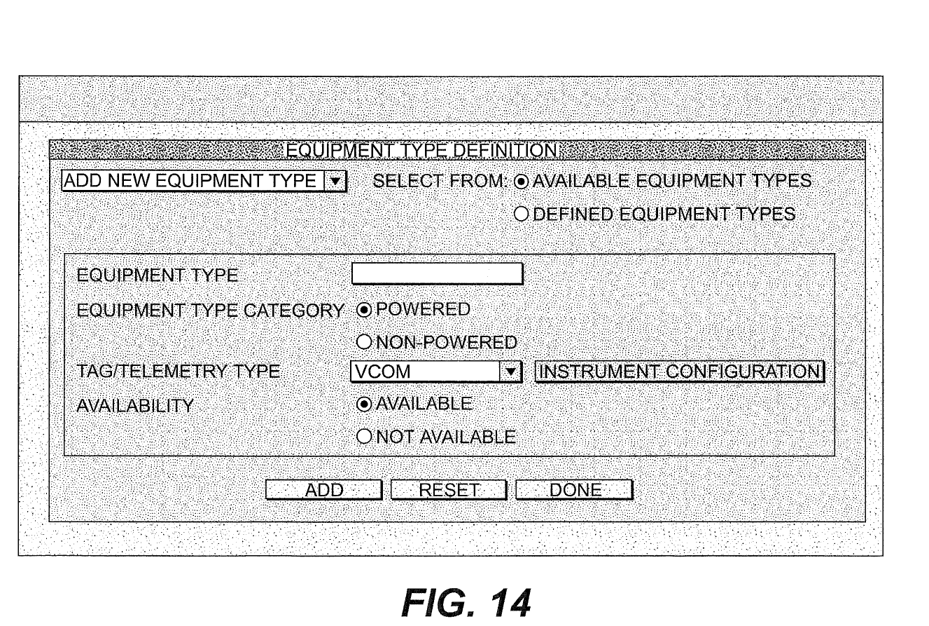

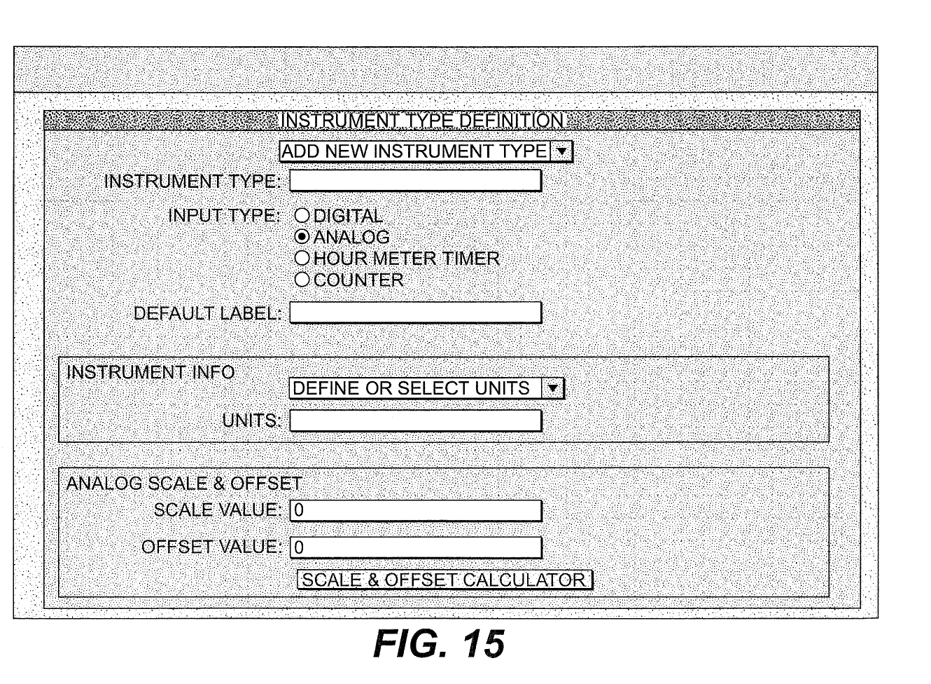

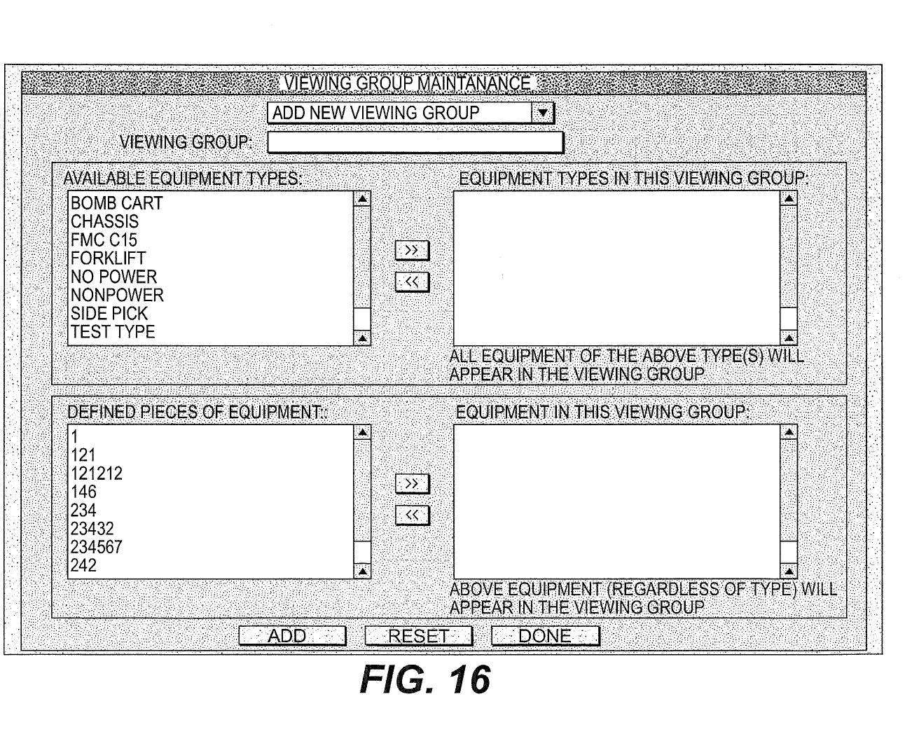

A graphical user interface may provide a window into the operations of the system. FIGS. 4-17b depict screen prints in accordance with an embodiment of the graphical user interface of the present invention. As embodied herein, the interface may integrate any one or more of the various modules of the present invention, which are described elsewhere in this specification. The interface may further comprise an executive portal function that displays selected parameters of interest to user(s) of the operation or systems being monitored.

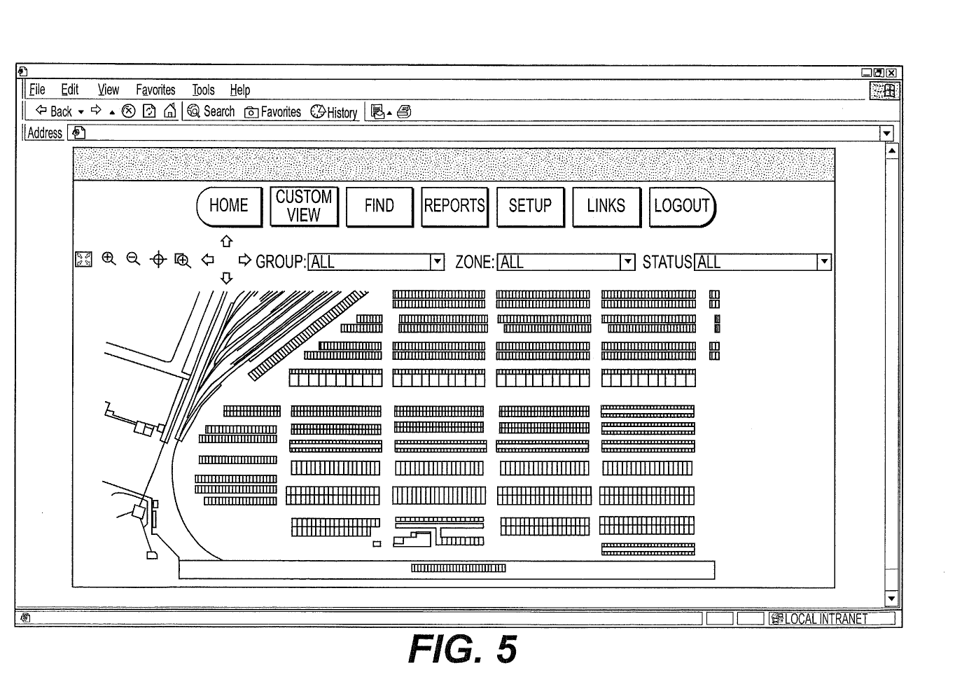

The graphical user interface may comprise an overall system map display. Such a display may comprise a map showing the physical location of all equipment, or assets, being monitored, such as that shown in FIG. 5. Additional information may be obtained about each piece of equipment, or asset, by clicking on a display icon for that object and launching additional more detailed screens. This “drill down” methodology may be used throughout the interface.

Functional schematic displays of all equipment, or assets, being monitored may be provided via the graphical user interface to monitor key equipment and system parameters. This information may be updated in real time as each piece of equipment updates its status through the system.

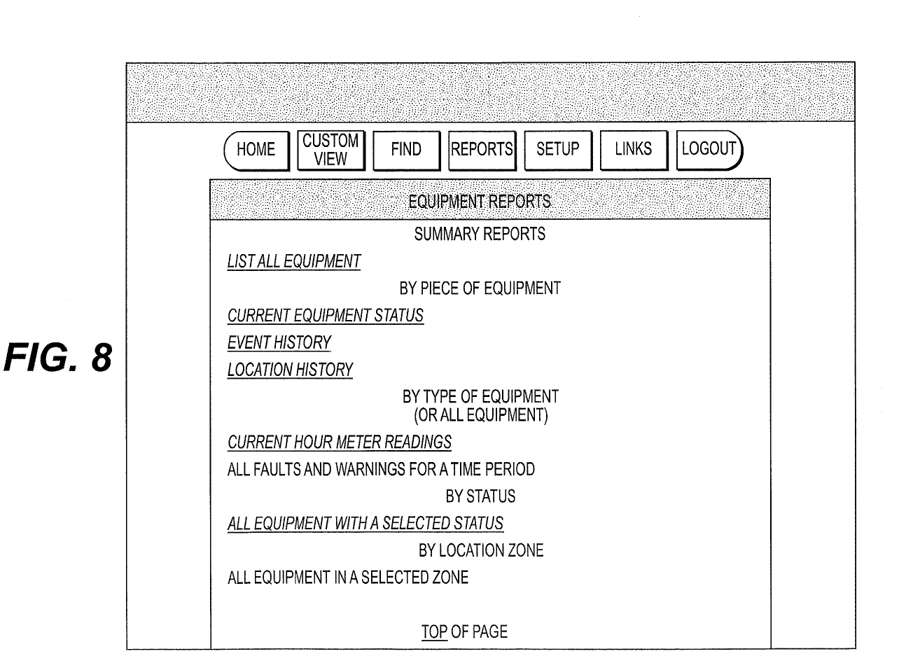

The graphical user interface may further include a reports utility to print or display current or historical information on all aspects of the system. This report generation function may enable a user to generate standard or customized reports that may be viewed on a computer screen, electronically filed, sent to a printer, or accessed by any other suitable means, such as the reports shown in FIGS. 8-11.

The graphical user interface may also comprise expert diagnostics tools. Additional Information on equipment, such as electrical and mechanical schematics and maintenance and operational manuals, may be accessible through an embodiment of the present invention for equipment maintenance and troubleshooting purposes. This may include, for example, automated software to assist an operator in diagnosing problems by responding to a series of questions.

Screen(s) may be provided by the graphical user interface to enable a user to quickly determine the overall operational status of the system, as shown in FIGS. 4-17b. The screen(s) may contain graphical representations of key system performance indicators that provide a snapshot of overall system status. A user may be provided with a utility to define those parameters and change them as needed. In addition, a user may get more detailed information by mouse clicking on an indicator icon on the screen(s). This may launch one or more screens with additional more detailed information.

### Method of the Present Invention

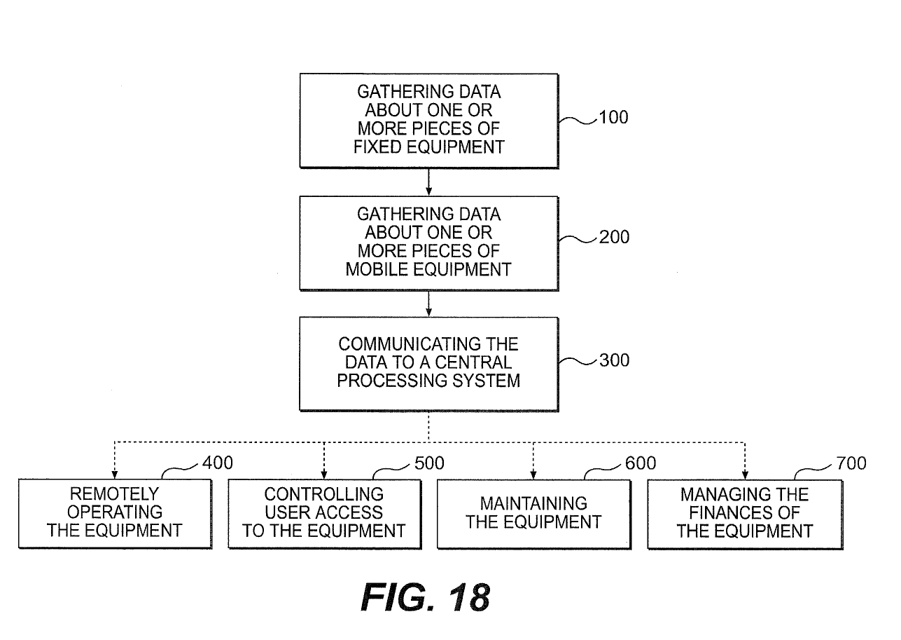

According to the present invention, the method for monitoring and managing equipment may comprise: gathering data about one or more pieces of fixed and mobile equipment 100/200; and communicating the data to a central processing system 300, as shown in FIG. 18. The data may be location and/or status data, particularly real-time data. The method may further comprise one or more of the following steps: remotely operating the equipment 400; controlling user access to the equipment 500; maintaining the equipment 600; and managing the finances associated with the equipment 700.

The method may use and the system may comprise one or more modules selected from among the group: monitoring and tracking; maintenance management; remote actuation; logistics; and financial management. As embodied herein, several of the modules may operate alone, while others may operate in combination. The modularity of certain embodiments of the present invention may enable a user to adopt certain modules that afford the greatest return on investment and to add additional modules, as they are needed.

Monitoring and Tracking of Fixed and Mobile Equipment

An embodiment of the present invention may comprise an automatic data collection system for obtaining real-time operational data from equipment, including various parameters such as, but not limited to: operational status; location; information about the operator of the equipment; and any other appropriate operational data. The module may comprise one or more of the following sub-systems, providing the functionalities: real-time location system (RTLS); asset data acquisition; automatic data collection (ADC) technologies; and operator input devices to support data collection. The sub-systems may communicate the data to the central processing system 400 via the communicating means 300. Software 430 included in the central processing system 400 may contain the program instructions for carrying out the monitoring and tracking functionalities. A user 500 may access the information via a graphical user interface.

An embodiment of the present invention may comprise RTLS, in which one or more location technologies may be employed to locate the physical position of mobile or temporarily positioned machinery and equipment. As embodied herein, these location technologies may comprise, but are not limited to, any one or more of: GPS; passive RFID; RF; antenna proximity triangulation; and differential time of arrival triangulation, as each is described above. A specific embodiment may comprise a location technology provided by WhereNet, which incorporates these locate functions. Software 430 included in the central processing system 400 may be adapted to process and/or store data collected by these location technologies.

An embodiment of the present invention may also include asset data acquisition. Communications means 300 may further comprise monitoring means for cooperating with equipment to record events and data, such as, but not limited to: whether the equipment is running; faults and problems; hours of operation; fuel and fluid levels; cycles of operation; and any other appropriate data. Monitoring means may monitor and transmit the recorded events and data via the communicating means 300 to the central processing system 400. Transmission(s) may occur via wired or wireless means, as described above.

An embodiment of the present invention may further comprise ADC technologies. Any of a number of data acquisition means may be employed, such as, but not limited to, any one or more of: bar code scanning; RFID; and other suitable ADC techniques. This module may facilitate recording information such as, but not limited to: materials processed; items handled; tasks accomplished; operator information; and any other appropriate information.

To support data collection, an embodiment of the present invention may comprise operator input devices. Operator(s) may enter data about an operation into the central processing system 400 via any of a variety of communications means, such as input devices of the types well known in the art, including, but not limited to, any one or more of: keyboard entry; wireless handheld devices; voice recognition; optical scanning; character recognition; ADC; or any other suitable techniques. Operators may enter data through any device that has access to the central processing system 400. Similarly, information may be sent to operators of equipment through the communicating means 300 of the central processing system 400.

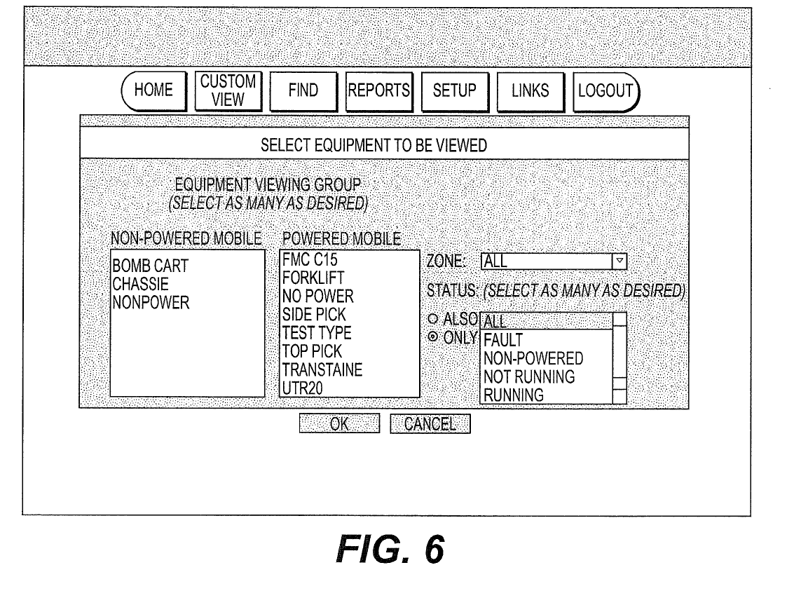

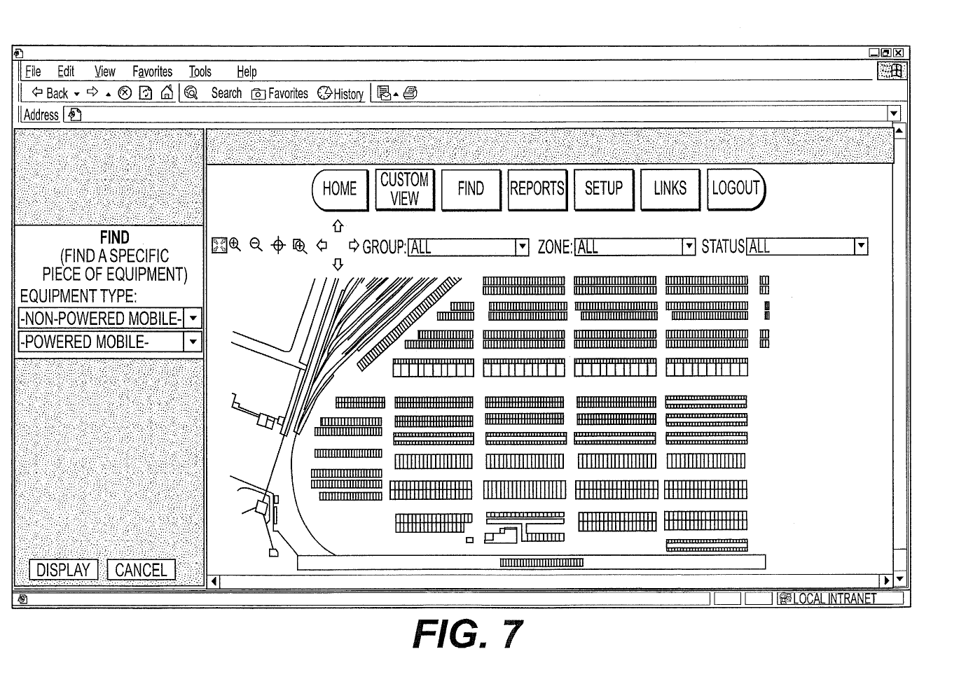

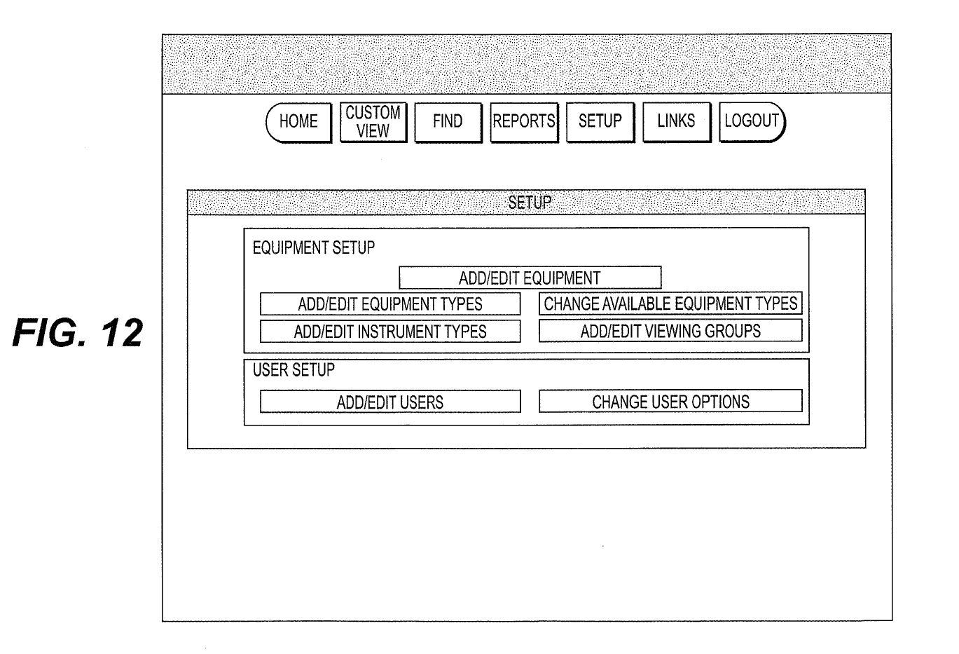

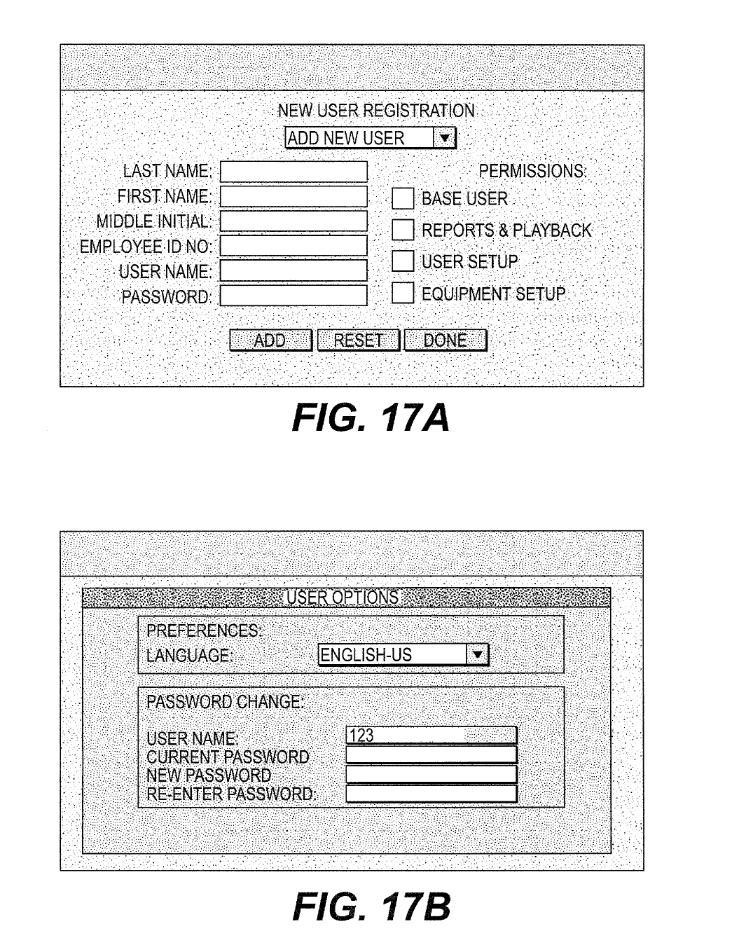

In an embodiment of the present invention, a user 500 may access the location and status information gathered and communicated to the central processing system 400 via a graphical user interface. The graphical user interface may be web-enabled. Initially, a user may gain access to the system by entering a user name and password on a log-on screen, such as that depicted in FIG. 4. If non-registered, the user may first register via a new user registration screen, as shown in FIG. 17a. Once successfully logged on, a user may access a screen depicting the layout of a facility, as shown in FIG. 5. The layout may depict all of the equipment within the facility that is being monitored and managed. As shown in FIG. 6, a user may select one or more pieces of equipment within the facility to be viewed. A user may also select a specific piece of equipment by highlighting the equipment on a screen, as depicted in the screen print of FIG. 7. A user may setup and change equipment parameters at any time, using screens such as those depicted in FIGS. 12-16. For example, a user may add or edit the types of equipment within the facility, the instrumentation of the equipment, or operator access to the equipment. As shown in FIGS. 8-11, various summary reports of location and status information may be generated by the system. A user may obtain specific information by selecting a report that meets their needs.

Computerized Maintenance Management System

An embodiment of the present invention may also be adapted to provide maintenance services. Persons of ordinary skill in the art are familiar with Computerized Maintenance Management Systems (CMMS) that are available prior to the present invention. An embodiment of the present invention may comprise an off-the-shelf CMMS that has been adapted to manage maintenance of facilities and equipment. Any of a number of prior known CMMS systems may be adapted to meet the specific needs of a user of the present invention. Specifically, a CMMS system may be adapted to interface with any of the other modules and to use the information infrastructure provided by the present invention to improve asset maintenance. For example, an embodiment of the present invention may use a product referred to as MP5i available from Datastream, which may be modified to perform management functions. Such functions may include, but are not limited to: periodic preventive maintenance planning and scheduling; spares inventory; employee training and qualification records; work orders; cost accounting; maintenance operations performance reporting; and any other suitable functions. Software 430 included in the central processing system 400 may contain the program instructions for carrying out the maintenance functionalities.

Remote Operation and Adjustment of Equipment

An embodiment of the present invention may comprise a remote operation and adjustment module that allows an operator to remotely control, change the operation status, and adjust operating parameters of machines and equipment, among other suitable remote operations. Functions that may be performed by the remote operation and adjustment module include, but are not limited to, one or more of the following: operator identification and vehicle access control; remote equipment operation; remote change of equipment status and operating parameters; remote equipment software upgrades; and power management. Software 430 included in the central processing system 400 may contain the program instructions for carrying out these functionalities.

An embodiment of the present invention may include operator identification and vehicle access control. This embodiment may limit access to equipment, allow operation of equipment only by authorized operators, record the identity of those who operate the equipment, and perform any other appropriate vehicle access functions. This embodiment may employ identification means, such as an identification card reader, connected to an onboard device that can electrically enable or disable the equipment. An identification card reader may be magnetic stripe type, proximity type, or any other appropriate reading device. The identification means may pass identification information from an operator's identification card or other access device to the onboard device. The onboard device in turn may determine whether the operator is authorized to operate the equipment. Authorization of the operator may be determined by the onboard device communicating with a central database of operators, which may be located on the central processing system 400. Alternatively, operator authorizations by individual or groups may be stored in memory internal to the device mounted on the equipment. If the operator is authorized, the onboard device may enable the vehicle. If the operator is not authorized, the device may not allow the operator to use the equipment. Embodiments of the present invention may further be adapted to report instances of attempts to secure unauthorized access to monitored equipment.

An embodiment of the present invention may further comprise additional security means. Such security means may: (1) disable equipment after a configurable period of time if an authorized operator logs in but does not actually start the equipment; and/or (2) disable equipment a configurable period of time after it is shut off. These additional features further decrease the chance of unauthorized vehicle operation.

The present inventors believe that the method of the present invention for determining operator authorization—without requiring consulting a central database—is novel. Prior to the present invention, operator card reader systems typically passed operator identification information to a central computer that in turn looks up authorizations on a table internal to the central computer. The central computer then may respond to the equipment to enable it or cause it to remain disabled. This prior known method may be employed in embodiments of the present invention, however it may be unsatisfactory in cases where communication between the equipment and a central computer is unreliable or not secure. For mobile equipment, in prior known systems this communication has been accomplished by radio frequency signal. In an industrial environment, the signal can become blocked or the equipment can be out of range. When this occurs, the equipment cannot be enabled and operated.

Other known systems have attempted to resolve this problem by carrying a complete copy of the operator authorization database on the onboard device of each piece of mobile equipment. This approach also entails problems, in that the database can become out of date on vehicles remaining out of radio range. In addition, the added memory requirements for the onboard device greatly increases total system cost. Embodiments of the present invention can avoid both of these problems by using identification means that are programmed with each operator's specific authorizations. The onboard device then only needs to store the authorization group or groups that the specific piece of equipment belongs to. The operator's identification card may carry information about the equipment groups the operator is authorized for in addition to an identification number that is unique to the operator. The onboard device then only has to determine if an operator is authorized for its vehicle group.

For example, if an operator is authorized to drive forklifts but not pickup trucks, this information may be recorded directly on their identification card. The onboard device on a forklift will recognize the authorization of this operator and enable the forklift for him or her; the onboard device on a pickup truck on the other hand will not recognize the operator and will not enable the pickup truck. This may be accomplished without any communication with a central processing system. An operator's unique identification number may be stored onboard or transmitted to a central processing system for storage when the vehicle is in radio range.

An embodiment of the present invention may also be adapted to remotely operate equipment. Remote operation may occur by: a centrally located operator who operates a number of pieces of equipment manually or initiates a piece of equipment to operate under fully automatic control; a series of one or more distributed operations centers remote to the equipment, or any appropriate location offering network access; or any other suitable means for remote operation.

A common problem in many complex operations is the lack of a sufficient number of trained and qualified operators to operate specific types of equipment. This type of constraint impairs efficiency and may prevent various operations from occurring at all. An embodiment of the present invention may alleviate this problem by allowing a single trained operator, or small group of operators, to operate a number of pieces of like equipment remotely from a central, or from a series of distributed, locations. Using data acquisition and sensor technologies, this embodiment may return enough data about a piece of equipment to allow an operator at a remote location to operate it just as if they were located at the equipment. Control circuits may allow the remote operator to control all aspects of the equipment.

For example, aircraft passenger boarding bridges at an airport may be remotely operated, saving gate personnel, flight crews, and passengers delays occasioned in awaiting the arrival of a qualified boarding bridge operator when a flight is arriving or departing. Boarding bridge equipment is operated in a non-continuous manner, and significant physical distances typically separate multiple units at an airport. As a result, operators are used inefficiently—they operate one unit for a short period of time then walk a potentially long distance to the next unit scheduled to be operated. The result is that more operators are required and the level of skill and experience of each operator is reduced. A centralized operator or operators may build greater skill and experience because a much greater proportion of their time may be spent operating the equipment. This may result in faster cycle times and greater asset utilization.

Human error is also a significant problem in any complex system. Embodiments of the present invention may reduce or potentially eliminate human error in many applications. In an embodiment of the present invention, sensors and data acquisition may be combined with microprocessors to fully automate the operation of equipment. With respect to the passenger boarding bridge example, the equipment itself may recognize that an aircraft is parked in position for the boarding bridge to dock to it. The boarding bridge may do this directly, via sensor technologies, or indirectly, via notification by another data system. The boarding bridge may automatically position itself to dock with the aircraft and complete the docking sequence. In a reverse process, the boarding bridge may undock from the aircraft upon notification that the aircraft is ready for departure. In certain embodiments, the boarding bridge or other automatically controlled equipment may be enabled by human actuation of a “deadman” switch. This may also help resolve constraints imposed by work rules or safety concerns that cannot be addressed by automatic controls. Use of a deadman enabling switch does not preclude the machine from conducting primary motions under fully automatic control.

An embodiment of the present invention may include remote change of equipment status and operating parameters. This embodiment may be adapted to provide a centrally located operator to remotely change equipment operational modes or to optimize operational parameters. Prior to the present invention, multiple machines involved in performing related tasks have had to be individually configured for their respective tasks. Human operators have had to be aware of each sub-task, coordinate the equipment manually to perform them, and set each machine with parameters appropriate for the task being accomplished.

For example, for a single piece of material that must be processed by multiple machine tools to become a finished part, generally each machine must be configured separately with data about the part as the part is ready for each operation in the process. In contrast, an embodiment of the present invention may pass data directly from machine to machine about the task at hand, automatically configuring each machine as required, without human intervention. This may result in faster process times and fewer errors due to incorrect setups.

In another example, when an aircraft is parked at an airport gate, the passenger boarding bridge, pre-conditioned air unit, ground power unit, potable water, fueling, and other systems must be set to service the specific type aircraft. An embodiment of the present invention may pass the parameters set at one machine to all the machines to correctly configure each of them. Therefore, once the passenger boarding bridge is docked to a Boeing 747 aircraft, for example, the boarding bridge equipment may pass data to: the pre-conditioned air unit, to select the correct operating mode for a jumbo aircraft; the power unit, to set the correct power output limits; the potable water, to select the correct flow and pressure; and any other appropriate equipment. The initial setting of mode or parameters on the first machine may be done by a human operator or by automatic recognition of the task at hand. For example, a visual docking guidance system (VDGS) or other data system may recognize the aircraft via a machine vision system and pass these parameters to other equipment.

An embodiment of the present invention may also allow local or remote uploads of software to microprocessor-controlled machines, as well as allows certain parameters in the control software to be modified. For example, the temperature set point at which an air conditioner/heater unit changes modes from cooling to heating may be remotely modified and saved in the memory of the unit's controller.

An embodiment of the present invention may further recognize an emergency power situation when backup generation comes online or power supply levels drop below specified limits. Such an embodiment may be adapted to shut down or reduce power to non-essential systems, while preserving the functionality of essential and safety-related systems.

Logistics: Automatic Dispatching, Operation Planning, and Management

In another embodiment, the present invention may provide decision-making tools to optimally allocate assets, such as, for example equipment. This module may comprise two discrete levels of functionality: centralized direction of assets; and automated asset allocation. The first may be used by operational personnel to direct the use of assets from a central location. Information may be displayed via the graphical user interface so that decisions can be made and communicated to direct operations. The second level may automate the decision-making process using software based upon rules that use asset status information to automatically make logistical decisions. Software capable of performing such functionalities would be known by those of ordinary skill in the art. The central processing system 400 may include such software 430 containing the program instructions for carrying out the following functionalities.

This module may be used to perform various functions including, but not limited to, any one or more of the following: two-way messaging to equipment operators; personnel allocation and assignment of duties; asset allocation planning; material movement management; aircraft fueling management; aircraft food delivery management; ground equipment vehicle refueling; management of deicing operations; electric vehicle battery management; automated guided vehicles for material movement; automated aircraft weight and balance control; automated aircraft push back; and aircraft docking and guidance system.

An embodiment of the present invention may include two-way messaging to equipment operators. The central processing system 400 may send text or voice communications to equipment operators by the communicating means 300. The communicating means 300 may be RF or any other suitable system or network. According to this embodiment, each piece of equipment, such as, for example, a tugger or forklift, may have RF terminal means to enable it to receive and send communications. This enables the module to dispatch operators and equipment, and provides a paperless audit trail on the use of the equipment.

An embodiment may also include personnel allocation and assignment of duties. This feature may facilitate planning of future personnel assignments by taking into consideration equipment availability and operator skills.

An embodiment of the present invention may further include asset allocation planning. This asset use planning tool may take into consideration asset type, work to be performed, maintenance requirements and available personnel, among other suitable considerations.

Material movement management may be included in an embodiment of the present invention. This may employ equipment status information to dispatch and control the movement of material. This functionality may include the movement of parts, supplies, mail, cargo, airline baggage, and any other appropriate materials. This may include tracking individual items that are moved as well. For example, a single piece of luggage may be tracked as it is moved within an airport.

Aircraft fueling management may also be included in an embodiment of the present invention. An aircraft fueling truck may be monitored to direct fuel truck drivers to aircraft requiring fuel. The time of fueling, operator, and quantity of fuel used may be tracked to verify operational compliance as well as for customer billing purposes.

An embodiment of the present invention may also include aircraft food delivery management. Aircraft food delivery trucks may be monitored to direct drivers to deliver food to departing aircraft. The time of delivery, number of units supplied, and the identification of the operator may be tracked to verify delivery and support customer invoicing.

Ground equipment vehicle refueling may further be included in an embodiment of the present invention. In an airport operation, for example, fuel needs periodically to be provided to various ground handling equipment, such as loaders, tuggers, and push-back tractors, to keep them operational. Fuel delivery trucks may be monitored to dispatch them for refueling operations. For example, the travel distance could be minimized while keeping equipment operational. Verification of delivery, quantity of product supplied, and the operator's identification could be tracked. This information may also be used for customer invoicing.

According to an embodiment of the present invention, aircraft deicing trucks and operations may be monitored to dispatch deicers to planes requiring deicing. The quantity of deicer fluids used, operator, and equipment identification may also be monitored to verify product delivery and used to generate customer invoices.

An embodiment of the present invention may also include electric vehicle battery management. Electric batteries are rapidly becoming a preferred power source for mobile equipment. Managing the use and recharging of these batteries may be essential to maximize operational uptime and equipment performance. Equipment may be monitored and tracked, along with battery charge levels. This information may be used to manage battery charging operations.

An embodiment of the preset invention may further include automated guided vehicles for material movement. Replacing equipment operators with mobile robots offers labor savings and an additional level of automation. Automatic guided vehicles may be used for mobile equipment operations and may be tracked and monitored through this embodiment of the present invention.

Automated aircraft weight and balance control may also be included in an embodiment of the present invention. When placing loads in an aircraft, it may be essential to properly balance and trim an aircraft prior to flight. Improper balance or trim may cause an aircraft to consume greater quantities of fuel than if balance is per manufacturers' specifications. The potential savings in fuel usage is substantial. This embodiment may use scales in conjunction with the communications infrastructure of the present invention to solve this problem. Scales that are flush with the airport tarmac may be placed under the wheels of the aircraft when the aircraft is parked at a gate. The scales may be monitored by this embodiment to determine the loading of the aircraft. As the aircraft is loaded for flight, this embodiment may provide feedback to loading personnel via radio terminals on the status of aircraft balance. Personnel may be directed to place loads on the aircraft in specific locations to optimize flight trim. Load balancing may be verified by continuously weighing the aircraft. This information may then be given to the aircraft-fueling operator to determine the required fuel for the flight. This information may be tracked and stored, providing an audit trail.

An embodiment of the present invention may further include automated aircraft push back. When leaving the gate, aircraft are typically pushed back from the gate by a manually driven push-back tractor. This vehicle requires a driver along with two spotters walking near the ends of each wing to watch for obstructions. The present invention may allow this process to be automated. While an aircraft is docked at the gate, a remotely controlled push-back tractor may be attached to the front wheels of the aircraft. When the aircraft is ready to leave the gate, a centrally located operator may initiate the push-back process. The operator may remotely monitor the push-back process as the automated push-back tractor pushes the aircraft back, detaches the aircraft's front wheels from the tractor, and then returns to the gate in a location that is clear for a new aircraft to dock at the gate.

An embodiment of the present invention may also include an aircraft docking and guidance system. This embodiment may combine aircraft docking and guidance system capabilities. Commercially available products are well known to persons of ordinary skill in the art. This may provide aircraft location information feedback to a pilot as the aircraft enters the gate area and guide the pilot so that the aircraft is properly located when it stops to be serviced by the gate equipment.

Financial Management

An embodiment of the present invention may further be adapted to manage all financial and accounting for a business. In addition to one or more of the preceding modules, an embodiment of the present invention may include a financial module, which may interact with information gathered by the other modules. Financial software 430 included in the central processing system 400 may contain the program instructions for carrying out the financial functionalities.

The financial management module may provide one or more of the following functions: general ledger; payroll; benefits; time management; accounts payable; accounts receivable; currency conversion; taxes; vouchers; inventory, personnel records; financial reporting such as profit and loss reports and balance sheets; and any other appropriate financial functions. Systems providing these functions are well known in the market, such as, for example, that provided by Oracle, and the present invention is adapted to support all such financial management systems as may be desired by a user. The module may be web-enabled and may be provided through an Application Service Provider (ASP) or client access may be provided directly to the system.

Embodiments of the present invention may be employed using any one or more of the modules described above, or any combination of any one or more of the functions described with respect to each of the modules. The following examples of certain embodiments of the present invention are intended to be illustrative only, to explain the operation of various embodiments of the present invention, and are not intended to limit in any way the scope of the present invention as claimed. Thus, it is intended that the present invention encompass all of the variations and permutations of the present invention, provided they come within the scope of the appended claims and their equivalents.

Paperless Maintenance Process

According to this example, an embodiment of the present invention may be adapted to provide end-to-end equipment maintenance, providing an audit trail, without paperwork. The process embodies the following steps:

A piece of equipment becomes due for either planned or unplanned maintenance.

A sensor automatically recognizes the need for maintenance and informs the central processing system 400.

If the equipment is down due to the event, the central processing system notifies the logistics module, which re-allocates tasks from the equipment that is down.

The embodiment opens a work order for the maintenance task.

the embodiment consults its database of maintenance personnel in the central processing system to find those who are currently on duty and qualified to perform the task.

The central processing system then notifies the appropriate maintenance personnel of the task (by onscreen notification, paging, or voice-synthesized radio message, for example).

An employee acknowledges receipt of the assignment via keyboard entry, handheld wireless device, and/or use of automatic data entry such as bar code scanning.

The employee commences the task.

Events are recorded during task completion, such as materials used, time required, and procedural/checklist steps completed via keyboard entry, handheld wireless device, and/or use of automatic data entry such as bar code scanning.

Upon completion of the maintenance task, the employee enters data about the task into the central processing system via keyboard entry, handheld wireless device, and/or use of automatic data entry such as barcode scanning.

the monitoring and tracking module of the present invention recognizes the availability of the equipment and notifies the logistics module that the equipment is available for use.

The central processing system assigns labor and materials to the work order and closes it, then passes costs, productivity and inventory information to the financial module.

The central processing system also automatically orders parts to replenish inventory, if necessary.

The financial module accounts for the event according to generally accepted accounting principles.

The graphical user interface retains data for reporting to management on parameters such as equipment uptime, mean time to repair and maintenance department productivity.

It will be apparent to persons of ordinary skill that the process of the above described embodiment may be modified without departing from the scope or spirit of the invention as claimed. For example, any of the various central processing system functions may be centralized or distributed. Dispatch could occur from a central location or at any other node in the system at which the information can be processed and coordinated reliably and/or effectively. The process could proceed with or without the steps of financial reporting, reordering parts, or any of the other specific functions. Thus, it is intended that the present invention cover all such modifications and variations of the invention, provided they come within the scope of the appended claims and their equivalents.

Combination of Location and Other Data to Derive Operational Information

In this example, real time location data may be combined with other data to produce operational information for managing mobile equipment. Examples include managing deicing compounds usage and tracking locations of containers, among other applications.

Aircraft deicing vehicles dispense costly deicing and anti-icing fluids on aircraft to remove ice and snow and to prevent re-freezing before takeoff. The exact amount of deicing fluids used on specific aircraft is valuable information to an airport operation in order to aid in cost recovery. This information is used to bill customers for deicing fluids used as well as to measure and improve deicing operations with the goals of increasing safety and decreasing deicing fluid consumption.

Prior to the present invention, a deicer operator would manually operate a ticket printer that prints fluid consumption on a paper ticket. The operator then noted on the ticket additional parameters, such as aircraft identification and times of the operation. This process resulted in clerically intensive additional effort to reconcile the tickets and create customer billing or other data. Prior known attempts to automate this process have fallen short because they have continued to require manual operator intervention to assign deicing fluids consumed to specific aircraft.

Use of the real time location system of embodiments of the present invention may resolve this problem by combining the fluid consumption data with location data of both deicing trucks and aircraft. This embodiment of the present invention may combine the data to determine the aircraft that was in the vicinity of the deicer when fluid was sprayed and automatically assign the consumed fluid to the aircraft. The invention then may pass the fluid data directly to the financial module or any other business system that is adapted to invoice the customer and create usage reports.

Tracking the actual physical location of individual shipping containers also poses significant difficulties for shipping ports. Containers are frequently misplaced, resulting in costly searches, expediting, and potentially lost revenue due to late ship departures or missed shipments. Tracking the containers directly via real time location technologies has thus far proven unworkable due to a combination of factors. First, the containers are very often not owned by the shipping companies. The shipping company, therefore, is typically unwilling to bear the expense of permanently tagging all of the containers it handles. Second, restrictive work rules make it either cost prohibitive or not immediately feasible to temporarily tag containers (as they enter the port and removing the tags upon departure). Third, the number of containers owned by a single shipping company can be very large, making permanently tagging the containers owned by the company an expensive project.

An embodiment of the present invention may address these problems by combining real-time location and status tracking of the equipment that is used to move the containers, rather than the containers themselves. Relatively few vehicles may be tracked rather than all of the containers. The location data for each vehicle may be combined with data received from sensors that determine whether the vehicle is currently handling a container. This embodiment may determine when and where a vehicle picks up and drops off a container. This data may be combined with data from an existing logistics system that currently records the identity of the container at specific locations for specific key transactions. The result may be continuous tracking of the current location of each container. This embodiment of the present invention may also track vehicle parameters for maintenance purposes.

Optimization of Aircraft Weight and Balance

According to another example, in airport operations, aircraft load planning is typically accomplished through a combination of manual and automated systems. A load planner receives data on proposed loads for the aircraft. This includes passenger baggage, cargo, and mail. The load planner then typically uses a software package to allocate aircraft space for each load to optimize aircraft balance. This loading manifest is then given to the ground team who will actually load the plane. Although the ground crew typically tries to adhere to the loading manifest, unplanned events such as missing or different loads than expected frequently arise, requiring adjustments to the plan. The team loading the aircraft then marks up the loading manifest and returns it to operations personnel. No independent verification of aircraft loading is typically provided. A conservative amount of fuel is then loaded into the aircraft to provide sufficient safety margins for the flight.

An embodiment of the present invention may track all loads being placed on an aircraft, such as, for example, baggage, cargo, and mail. Information about these loads, such as size and weight, may be essential for load planning. In addition, the actual weight of the aircraft may be determined by placing weigh scales under the aircraft's wheels while at the gate. The system may use real-time information to continuously update the load plan as the aircraft is being loaded and provide feedback to the ground team loading the aircraft through a radio terminal. In this manner, the aircraft may be optimally loaded for flight. The exact amount of fuel may be loaded on the aircraft for safe flight, leading to substantial fuel savings, a reduction in flight stress on the aircraft and the problem of not having enough fuel. No such system is known prior to the present invention.

Tracking of Fixed, Mobile Powered and Mobile Non-Powered Equipment

According to another example, an embodiment of the present invention may be adapted to track fixed, powered mobile, and non-powered mobile equipment. By contrast, systems known prior to the present invention are focused on monitoring and/or tracking equipment in only one of these general categories.

Fixed equipment is that which is fixed in place during and between use and may include machine tools, fixed construction equipment such as rock crushers, facility equipment, such as elevators, escalators and air conditioners, bridge cranes and port cranes, and fixed equipment at airports such as bag handling equipment, point-of-use ground power units, pre-conditioned air units, and passenger boarding bridges.

Mobile powered equipment may include any motorized equipment that is readily mobile during or between operation, such as forklifts, construction vehicles, trucks, trailer-mounted powered equipment such as mobile generator sets and portable welders, and self-propelled airport ground support equipment. Mobile non-powered equipment may include any type of mobile equipment that is not self-powered, such as trailers, carts, jigs and fixtures, aircraft tow bars, and any other portable equipment and tooling.

Fixed equipment may be tracked for status information. As the location of the fixed equipment is known, location of fixed equipment may not be tracked in certain embodiments of the present invention. Powered mobile equipment may be tracked and monitored for location as well as status information. Non-powered mobile equipment may be tracked for location only. In other embodiments of the present invention, location of fixed and non-powered mobile equipment may be tracked as a means of theft detection and/or deterrence. For fixed and powered mobile equipment, two-way systems can provide control as well as status monitoring from a single computer interface.

Simultaneous Use of Multiple Location Technologies for Mobile Equipment

In another example, real time location of mobile equipment may be used to improve business processes and performance. Like any technology, the various methods used to produce real time location data each have their advantages and disadvantages. Simultaneous use of two or more location technologies to locate a given piece of mobile equipment can overcome the deficiencies of each system when used alone.

For example, GPS-based locating systems have the advantage of being able to determine the location of a piece of equipment virtually anywhere in the world. In an embodiment of the present invention, this location information is passed to a centralized processing system remote from the equipment using narrow band, long-range radio signals, or a wireless communication network of the type well known in the art. The centralized processing system, in turn, allows the location information to be used for equipment, operations, and fleet management applications.

As discussed above, GPS has several significant disadvantages in that it cannot locate equipment indoors, under roofs or overhangs, when equipment is close to a large structure, or in other orientations when the necessary satellite fixes are unavailable. GPS based systems, therefore, are not well suited for equipment that is operated in these environments.

RF-based real-time locating technologies use various methods such as ranging and multi-lateration by which multiple radio antennas in an area locate tags attached to equipment. As discussed above, these systems have an advantage of functioning indoors and outdoors, but have a disadvantage of only being able to locate equipment in a well-defined and limited area of coverage.

Neither solution is fully satisfactory for locating equipment that operates over a large region that includes both indoor and outdoor areas, such as many airports. Yet, an embodiment of the present invention may combine location data received from both GPS-based and RF-based real time locating systems. Such an embodiment may display and use both types of location data seamlessly in a single application. In such an arrangement, equipment that ranges over broad areas outdoors may have GPS modules only. Equipment that operates primarily indoors or in specific areas may use RTLS for location. Equipment that ranges over all areas may simultaneously use both GPS and RTLS to provide continuous location data.

Embodiments of the present invention may integrate technology in both the central processing system and the mobile tracking devices mounted on equipment that makes the use of multiple location technologies possible. Software on the central processing system may seamlessly receive location data of different types and format and combine them into a single location database and display. Mobile devices may be adapted to use either or both GPS and RTLS location modules on a single vehicle, passing the location data from the vehicle to the central processing system.

It will be apparent to persons of ordinary skill in the art that various modifications and variations may be made to the present invention without departing from the scope or spirit of the invention. For example, the various modules described above may be modified and/or adapted to various applications. The invention has been illustrated with respect to various types of airport operations, yet the invention may have utility in other airport applications as well as in different applications, such as stacking shipping containers, and other industrial and commercial operations. Further, one or more of the various modules, either as described above, or as modified may be used in various combinations with one or more other modules. In addition, one or more of the various functions described above may be combined to provide the user the desired benefits. Thus, it is intended that the present invention cover all such modifications and variations of the invention, provided they come within the scope of the claims and their equivalents.

What is claimed is:

1. A system for monitoring and managing equipment, comprising:
one or more mobile pieces of equipment;
one or more fixed pieces of equipment;
a central processing system; and
one or more means for communicating data between said equipment and said central processing system.

2. The system according to claim 1, wherein said mobile equipment further comprises powered mobile equipment and non-powered mobile equipment.

3. The system according to claim 1, wherein said communicating means comprises a radio frequency network.

4. The system according to claim 3, wherein said radio frequency network further comprises at least one equipment mounted device communicating via low-power radio frequency with at least two antennae.

5. The system according to claim 1, wherein said communicating means comprises a cellular network.

6. The system according to claim 1, wherein data comprises data about a location of said equipment.

7. The system according to claim 1, wherein said data comprises data about an operational status of said equipment.

8. The system according to claim 1, further comprising a graphical user interface enabling a user to interact with said central processing system.

9. The system according to claim 1, further comprising means for remote operation of said equipment based upon said data communicated to said central processing system.

10. The system according to claim 9, wherein said means for remote operation are fully automated.

11. The system according to claim 1, further comprising means for controlling operator access to said equipment.

12. The system according to claim 11, wherein said means for controlling operator access further comprises:
an onboard device mounted on said equipment that enables or disables said equipment;
an identification card reader connected to said onboard device;
one or more operator identification cards containing information about the operator, said identification cards being read by said identification card reader; and
a database of operators, which communicates with said identification card reader.

13. A system for monitoring and managing equipment, comprising:
one or more mobile pieces of equipment;
one or more fixed pieces of equipment;
a plurality of distributed processing systems;
one or more means for communicating data between said equipment and said processing systems; and
means for remote operation of said equipment based on data communicated to said processing systems.

14. A method for monitoring and managing equipment, comprising the steps of:
gathering data about one or more pieces of fixed equipment;
gathering data about one or more pieces of mobile equipment; and
communicating the data to a central processing system.

15. The method according to claim 14, wherein the step of gathering data about one or more pieces of mobile equipment further comprises gathering data about the location of the equipment.

16. The method according to claim 15, further comprising the step of processing the location data at the central processing system to determine the physical location of the mobile equipment.

17. The method according to claim 16, wherein the step of processing the location data further comprises the step of triangulating the physical location of the mobile equipment.

18. The method according to claim 14, wherein the step of gathering data about one or more pieces of equipment further comprises the step of monitoring the operational status of the equipment.

19. The method according to claim 18, wherein the step of monitoring the operational status is selected from the group consisting of monitoring one or more of:
equipment running status; faults and problems; hours of operation; fuel levels; fluid levels; cycles of operation; materials processed; items handled; tasks accomplished; and operator information.

20. The method according to claim 14, wherein the step of communicating the data further comprises communicating via a radio frequency network.

21. The method according to claim 14, wherein the step of communicating the data further comprises communicating via combination of a radio frequency network and a global positioning system network.

22. The method according to claim 14, wherein the step of communicating the data further comprises inputting data via a device selected from the group consisting of:
keyboard entry; wireless handheld device; voice recognition; optical scanning; character recognition; and automatic data collection.

23. The method according to claim 14, further comprising the step of remotely operating the equipment based upon data communicated to the central processing system.

24. The method according to claim 23, wherein the step of remotely operating the equipment further comprises automatically dispatching the equipment.

25. The method according to claim 14, further comprising the step of controlling operator access to the equipment.

26. The method according to claim 25, wherein the step of controlling operator access further comprises the steps of:
identifying an operator of the equipment;
determining authorization to operate the equipment based upon the operator identification; and
enabling the equipment if authorization is allowed.

27. The method according to claim 25, wherein the step of controlling operator access further comprises the step of disabling the equipment after a configurable of time.

28. The method according to claim 14, further comprising the step of maintaining the equipment based on the data communicated to the central processing system.

29. The method according to claim 14, further comprising the step of managing the finances of a business based on the data communicated to the central processing system.

30. A method for maintaining equipment, comprising the steps of:
remotely sensing a need for maintenance;
communicating the need to a central processing system;
re-allocating the equipment's tasks;
opening a work order for the maintenance task;
assigning the task to the appropriate maintenance personnel;
acknowledging receipt of the assignment;
recording in a manner adapted to communicate with the central processing system events during task completion;
recognizing the availability of the equipment; and
notifying the central processing system that the equipment is available for use.

31. The method according to claim 30, further comprising the steps of:
assigning cost, productivity, and inventory information to the work order;
accounting for the maintenance according to generally accepted accounting principles; and
reporting parameters relating to the maintenance.
